(19) United States
(12) Patent Application Publication
(10) Pub. No.: US 2020/0201488 A1
(43) Pub. Date: Jun. 25, 2020

(54) USER INTERFACE FOR REPLYING PRIVATELY TO POSTS

(71) Applicant: Microsoft Technology Licensing, LLC, Redmond, WA (US)

(72) Inventors: Shu-Yi Zhou, San Francisco, CA (US); Yizhou Pan, Sunnyvale, CA (US); Adam Leon, San Francisco, CA (US); Yitian Xu, San Francisco, CA (US); Cameron Askew, Sunnyvale, CA (US)

(21) Appl. No.: 16/231,182

(22) Filed: Dec. 21, 2018

(51) Int. Cl. G06F 3/0482; G06F 3/0484

(52) U.S. Cl. CPC G06F 3/0482; G06F 3/0484

(57) ABSTRACT

In some embodiments, a computer system detects that a digital content item associated with a second user is to be displayed in a data feed of a first user, determines that the first user has a connection with the second user that satisfies a connection criteria that the connection be of at least a predetermined degree, causes a first selectable user interface element to be displayed in association with the digital content item in the data feed of the first user based on the determining that the first user has the connection with the second user that satisfies the connection criteria, and causes a message creation element to be displayed in response to the a user selection of the first selectable user interface element, with the message creation element comprising an address field that is auto-populated to identify the second user as the only recipient of a message.

### TECHNICAL FIELD

The present application relates generally to systems, methods, and computer program products f©r providing a user interface configured to enable a user to efficiently and conveniently reply privately to a posting of a digital content item within a data feed of the user.

### BACKGROUND

Computer systems of online services that provide data feeds of digital content items to users lack an efficient and convenient way for a user to reply privately to another user associated with a digital content item that is displayed within the data feed of the user, such as another user who created an online post displayed within the data feed or performed a viral action directed to an online post that is indicated within the data feed. Furthermore, there lacks an efficient and convenient way to include a representation of the digital content item in such a private reply. Although selectable options for liking, commenting on, and sharing digital content items may be available to the user, these forms of reply are not private between the user and the other user associated with the digital content item, but rather are visible to other users as well, and they do not include any representation of the digital content item. As a result of these deficiencies, if a user wants to reply privately to a digital content item and include a representation of the digital content item in the private reply, the user must go through the inconvenient process of copying a representation of the digital content item, navigating to a profile page of the other user, selecting to message the other user via the profile page, pasting the copied representation of the digital content item into the message, adding additional commentary to the message, and selecting to send the message. This process wastes time and electronic resources, requiring the user to navigate to another page, which increases the chances of interference with the process (e.g., browser freeze, system crash, and so on). Other technical problems may arise as well.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating a feed system, in accordance with an example embodiment.

FIG. 4 illustrates a graphical user interface (GUI) in which a data feed of digital content items is displayed, in accordance with an example embodiment.

FIG. 5 illustrates a message creation element, in accordance with an example embodiment.

FIG. 6 illustrates another message creation element,accordance with an example embodiment.

FIG. 7 is a flowchart illustrating a method of providing a user interface configured to enable a user to efficiently and conveniently reply privately to a posting of a digital content item within a data feed of the user, in accordance with an example embodiment.

FIG. 8 is a flowchart illustrating a method of using the user's private reply to determine other digital content items to display to the user, in accordance with an example embodiment.

FIG. 9 is a block diagram illustrating a mobile device, in accordance with some example embodiments.

FIG. 10 is a block diagram of an example computer system on which methodologies described herein may be executed, in accordance with an example embodiment.

### DETAILED DESCRIPTION

### I. Overview

Example methods and systems of providing a user interface to enable a user to efficiently and conveniently reply privately to a posting of a digital content item within a data feed of the user are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein, which provide methods and user interfaces for replying privately to a posting of a digital content item within a data feed of the user in a convenient and efficient manner. In some example embodiments, a computer system detects that a digital content item is to be displayed in a data feed of a user of an online service, and determines whether certain criteria is satisfied, such as whether the user has a connection of a predetermined degree with another user that is associated with the digital content item. If the criteria is satisfied, such as by the user having a first degree connection with the other user associated with the digital content item, then the computer system displays a selectable user interface element in association with the digital content item in the data feed of the user. The selectable user interface element is configured to, based on its selection by the user, cause a message creation element to be displayed. The message creation element is configured to receive user-entered text to include in a message and comprises an address field that is auto-populated to identify the other user as the only recipient of the message. In some example embodiments, the message creation element is also auto-populated with an indication that the message will include a representation of the digital content item, such as some or all of the digital content item or a link to the digital content item.

The implementation of the features disclosed herein involves a non-generic, unconventional, and non-routine operation or combination of operations. By applying one or more of the solutions disclosed herein, some technical effects of the system and method of the present disclosure are to provide a convenient and efficient way for a user of an online service to reply privately to a posting of a digital content item within a data feed of the user and to include a representation of the digital content item in the private reply. As a result, the functioning of the computer system of the online service is improved, as browser navigation is reduced and electronic resources are conserved, decreasing the risk of interference, such as the browser freezing or crashing. Other technical effects will be apparent from this disclosure as well.

### II. Detailed Example Embodiments

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

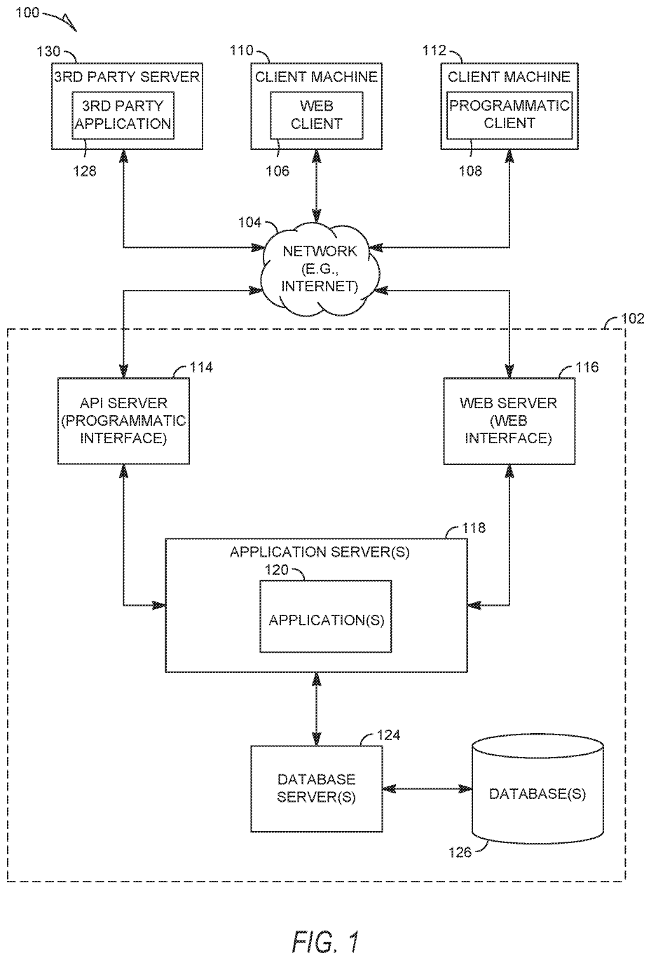

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

in some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

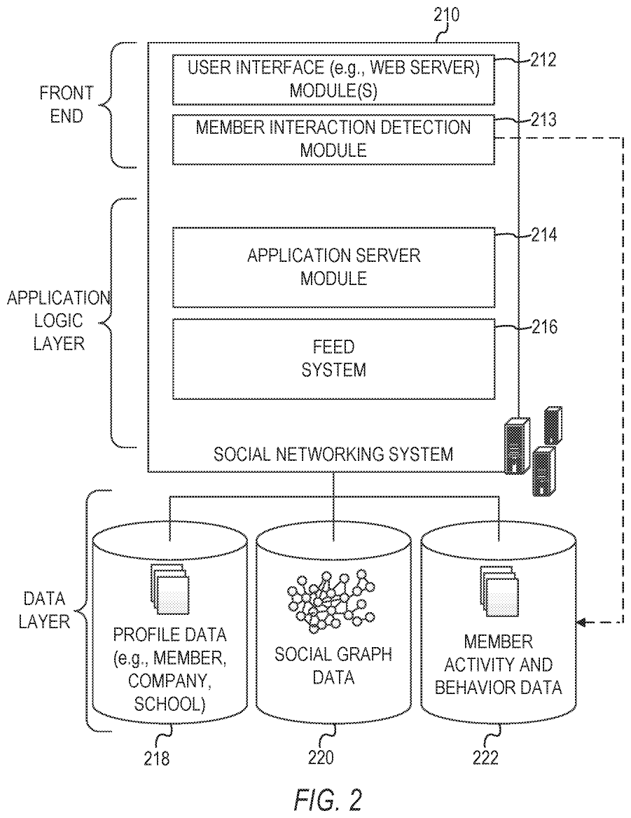

In some embodiments, the networked system 102 may comprise functional components of a social networking service. FIG. 2 is a block diagram showing the functional components of a social networking system 210, including a data processing module referred to herein as a feed system 216, for use in social networking system 210, consistent with some embodiments of the present disclosure. In some embodiments, the feed system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the feed system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222. This logged activity information may then be used by the feed system 216. The members' interactions and behavior may also be tracked, stored, and used by an feed system 216 residing on a client device, such as within a browser of the client device, as will be discussed in further detail below.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the feed system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

In some example embodiments, the features of the feed system 216 provide a convenient and efficient way for a user to privately reply to the creator of a post discovered on the user's feed or the root actor of a viral update discovered on the user's feed. Users no longer have to navigate to a different page to start the messaging action, but rather can start it from the digital content item in the data feed itself using a selectable user interface element.

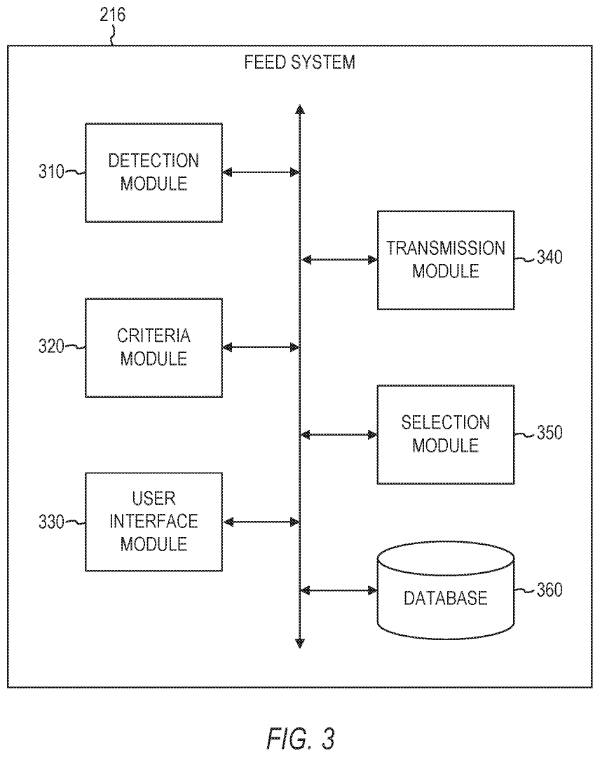

FIG. 3 is a block diagram illustrating the feed system 216, in accordance with an example embodiment. In some embodiments, the teed system 216 comprises any combination of one or more of a detection module 310, a criteria module 320, a user interface module 330, a transmission module 340, a selection module 350, and one or more databases 360. The modules 310, 320, 330, 340, and 350 and the database(s) 360 can reside on a computer system, or other machine, having a memory and at least one processor (not shown). In some embodiments, the modules 310, 320, 330, 340, and 350 and the database(s) 360 can be incorporated into the application server(s) 118 in FIG, 1. In some example embodiments, the database(s) 360 is incorporated into database(s) 126 in FIG. 1 and can include any combination of one or more of databases 218, 220, and 222 in FIG. 2. However, it is contemplated that other configurations of the modules 310, 320, 330, 340, and 350, as well as the database(s) 360, are also within the scope of the present disclosure.

In some example embodiments, one or more of the modules 310, 320, 330, 340, and 350 is configured to perform various communication functions to facilitate the functionality described herein, such as by communicating with the social networking system 210 via the network 104 using a wired or wireless connection. Any combination of one or more of the modules 310, 320, 330, 340, and 350 may also provide various web services or functions, such as retrieving information from the third party servers 130 and the social networking system 210. Information retrieved by the any of the modules 310, 320, 330, 340, and 350 may include profile data corresponding to users and members of the social networking service of the social networking system 210.

Additionally, any combination of one or more of the modules 310, 320, 330, 340, and 350 can provide various data functionality, such as exchanging information with the database(s) 360 or servers. For example, any of the modules 310, 320, 330, 340, and 350 can access member profiles that include profile data from the database(s) 360, as well as extract attributes and/or characteristics from the profile data of member profiles. Furthermore, the one or more of the modules 310, 320, 330, 340, and 350 can access profile data, social graph data, and member activity and behavior data from the database(s) 360, as well as exchange information with third party servers 130, client machines 110, 112, and other sources of information.

in some example embodiments, the feed system 216 is configured to enable a user to efficiently and conveniently reply privately to a posting of a digital content item within a data feed of the user. A data feed is a mechanism for users to receive updated data from data sources. In some example embodiments, the data feed of a user comprises a plurality of digital content items, such as online posts created by other users and indications of viral actions of other users directed to online posts. An online post may comprise any content published on a networked site, such as content published by a member of a social networking site on the social networking site. Such content may include, but is not limited to, text, copies of documents, links to documents, images, videos, or any combination thereof. In some example embodiments, a post is displayed in a feed of content that is presented to a user of the networked site on which the post is published, such as to a member of a social networking site. Such content feeds may be personalized for the specific user to which they are being presented. For example, the selection of content in a feed may be determined based on information about the specific user, such as profile data from database 218 in FIG. 2), social graph data (e.g., from database 220 in FIG. 2), and member activity and behavior data (e.g., from database 222 in FIG. 2).

In some example embodiments, a viral action comprises any online action by a user that results in a digital content item being displayed to one or more other users based on the one or more other users having a connection with the user that performed the online action. Examples of viral actions may include, but are not limited to, a user liking a digital content item, a user commenting on a digital content item, a user sharing a digital content item, and a user updating his or her profile data (e.g., adding profile data, deleting profile data, editing profile data). Other types of viral actions are also within the scope of the present disclosure. Additionally, other types of viral updates may also be displayed as digital content items within the data feed of a user, such as any events associated with a profile of another user having a connection with the user (e.g., a work anniversary indicated by profile data of the other user).

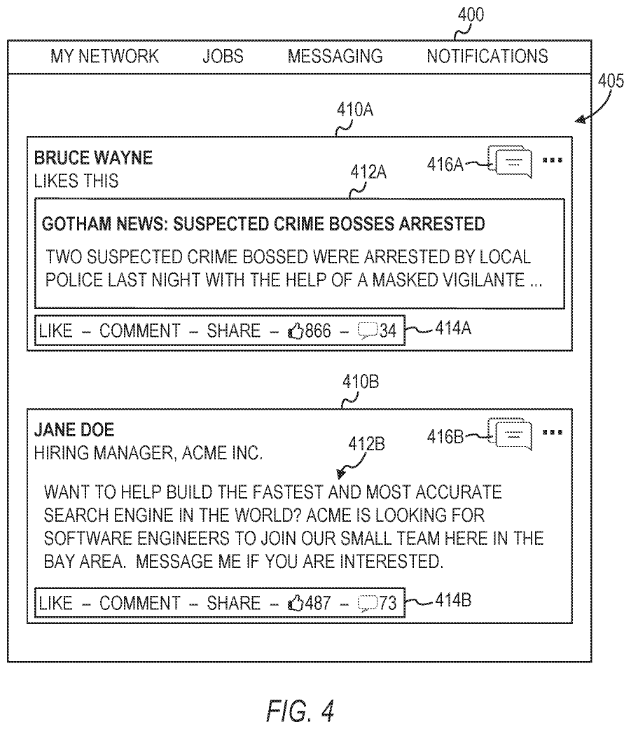

In some example embodiments, the detection module 310 is configured to detect that a digital content item is to be displayed in a data feed of a first user of an online service. FIG. 4 illustrates a GM 400 in which a data feed 405 of digital content items 410 is displayed, in accordance with an example embodiment. The data feed 405 may comprise more than one digital content item 410. For example, in FIG. 4, the data feed 405 comprises a first digital content item 410A and a second digital content item 410B.

In some example embodiments, the digital content item detected by the detection module 310 is associated with a second user of the online service. For example, in some example embodiments, the digital content item comprises an online post created by the second user (e.g., an online article authored by the second user, a job posting authored by the second user). In some example embodiments, the digital content item comprises an indication of a viral action associated with the second user (e.g., the second user liking a digital content item, the second user commenting on a digital content item, the second user sharing a digital content item, the second user updating his or her profile data, events associated with a profile of the second user). In the example shown in FIG. 4, the digital content item 410A comprises an indication of a viral action by the second user directed to an online post 412A. The viral action indicated in the digital content item 410A is a user liking the online post (e.g., Bruce Wayne liking the online article from Gotham News in FIG. 4). Additionally, in the example shown in FIG. 4, the digital content item 410B comprises an online post 412B created by another user (e.g., a job opportunity authored by Jane Doe in FIG. 4).

In some example embodiments, the criteria module 320 is configured to, prior to the digital content items 410 being displayed in the data feed 405, determine whether or not a criteria is satisfied. In some example embodiments, the criteria comprises a connection criteria comprising a requirement that the first user and the second user have a connection of at least a predetermined degree. A user's social network is made up of different degrees of connections with other users, such as first degree connections, second degree connections, third degree connections, and so on and so forth. A first degree connection between the first user and the second user is a direct connection between the first user and the second user, in which either one of the first user and the second user accepts an invitation to connect from the other one of the first user and the second user. A second degree connection between the first user and the second user is an indirect connection between the first user and the second user, in which the first user is directly connected to a third user that is directly connected to the second user. Other degree connections (e.g., third degree connection, fourth degree connection, etc.) follow this pattern of introducing other directly-connected users in the indirect connection between the first user and the second user.

In some example embodiments, the predetermined degree may be a first degree connection. However, it is contemplated that other connection degrees (e.g., second degree connection, third degree connection, etc.) may be used as the predetermined degree, such that the connection between the first user and the second user is at least of the predetermined degree (e.g., a second degree connection would satisfy a connection criteria having a predetermined degree of a third degree connection, since the second degree connection is a higher or stronger degree connection than a third degree connection).

In some example embodiments, the criteria comprises a criteria other than the connection criteria, such as criteria based on at least one of the digital content item, profile data of the first user, and profile data of the second user associated with the digital content item. For example, the other criteria may be that the profile data of the first user and the profile data of the second user are determined to be sufficiently similar (e.g., the first user and the second user have similar interests, work for the same company, or work in similar industries), or that the digital content item is of a particular type (e.g., the digital content item comprises an indication of a job opportunity).

In some example embodiments, the user interface module 330 is configured to cause a first selectable user interface element to be displayed in association with the digital content item in the data feed of the first user within a user interface of a computing device of the first user based on a determination by the criteria module 320 that the criteria is satisfied. In FIG. 4, first selectable user interface elements 416A and 416B are displayed in association with their corresponding digital content items 410A and 410B, respectively. In some example embodiments, the first selectable user interface elements 416 comprise a selectable icon. However, other types of selectable user interface elements 416 are also within the scope of the present disclosure. In some example embodiments, the first selectable user interface element 416 is displayed separately from a user interface area 414 comprising viral action options, such as a selectable option to like content (e.g., “LIKE” in FIG. 4), a selectable option to comment on content (e.g., “COMMENT” in FIG. 4), and a selectable option to share content (e.g., “SHARE” in FIG. 4). For example, in FIG. 4, the selectable user interface elements 416A and 416B are displayed separately from user interface areas 414A and 414B comprising viral action options. This separation of the display locations for the first selectable user interface element 416 and the user interface area 414 comprising the viral action options significantly improves the GUI 500, making it more convenient for the user to find and select the first user interface element 416.

In some example embodiments, the detection module 310 is configured to a user selection of the first selectable user interface element 416. Examples of the user selection include, but are not limited to, a clicking or a tapping of the first selectable user interface element 416 by the first user.

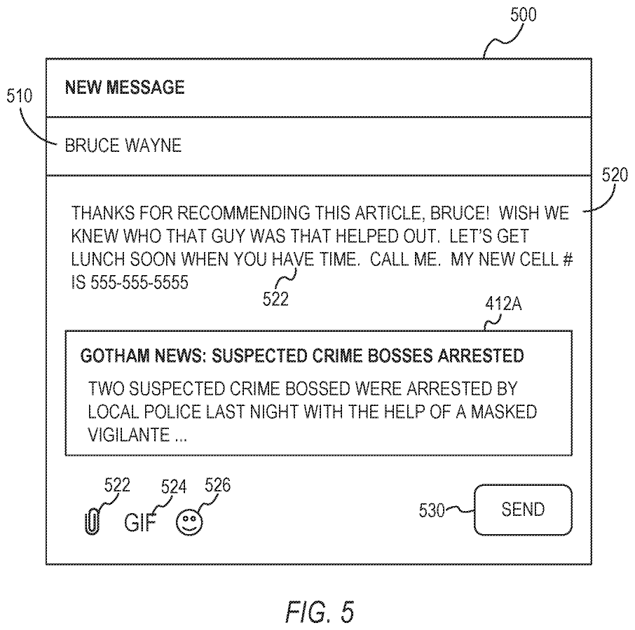

In some example embodiments, the user interface module 330 is configured to cause a message creation element to be displayed within the user interface of the computing device in response to the detection of the user selection of the first selectable user interface element 416. FIG. 5 illustrates a message creation element 500, in accordance with an example embodiment. In some example embodiments, the message creation element 500 comprises a graphical control, such as a pop-up window overlaying the GUI 400 or an independent window separate from the GUI 400, in which the first user may configure a message for transmission. In some example embodiments, the message creation element 500 comprises an address field 510 that is auto-populated to identify the second user as the only recipient of the message, thereby automatically configuring the message as a private message between only the first user and the second user, omitting any other users connected to the first user or the second user from being included as recipients of the private message. For example, in response to the first user selecting the first selectable user interface element 416A in FIG. 4, which corresponds to the digital content item 410A associated with “BRUCE WAYNE,” the user interface module 330 causes the message creation element 500 to be displayed, as shown in FIG. 5, with the address field auto-populated to identify “BRUCE WAYNE” as the only recipient of the message from the first user, omitting any other users from being included as recipients of the private message.

In some example embodiments, the message creation element 500 is configured to receive user-entered text to include in a message to be transmitted via the message creation element 500. For example, the message creation element 500 may comprise a text field 520 in which the first user may enter and edit text 522 to be included in the message.

In some example embodiments, the user interface module 330 is configured to auto-populate the message creation element 500 with an indication that the message will include a representation of the digital content item 410A. Examples of the representation of the digital content item 410A include, but are not limited to, at least a portion of the digital content item 410A and a link to the digital content item 410A. In the example shown in FIG. 5, the representation of the digital content item 410A comprises the online post 412A of the digital content item 410A.

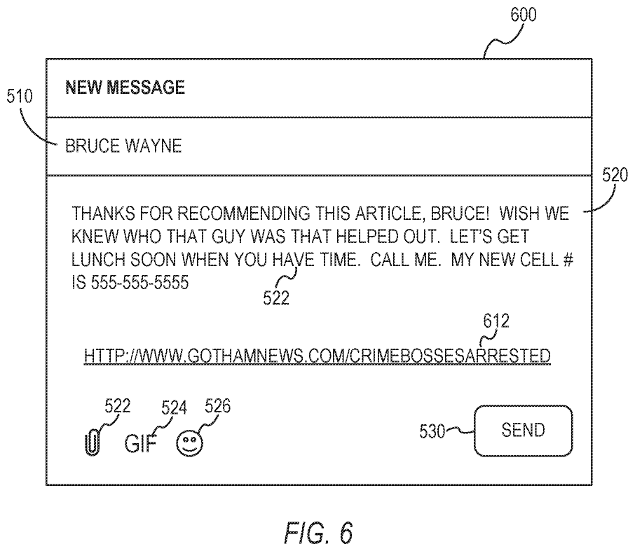

FIG. 6 illustrates another message creation element 600, in accordance with an example embodiment. The message creation element 600 in FIG. 6 is the same as the message creation element 500 in FIG. 5, except for the representation of the digital content item 410A. In the example shown in FIG. 6, the representation of the digital content item comprises a link 612 to the digital content item 410A or to the online post 412A of the digital content item 410A. In some example embodiments, the message creation element 500 is configured to enable the first user to edit the link 612, such as by entering or deleting text.

In some example embodiments, the user interface module 330 is configured to receive a user input requesting transmission of the message. For example, the first user may request transmission of the message by selecting (e.g., clicking, tapping) a selectable user interface element displayed in association with the message creation element, such as a selectable “SEND” button 530 presented as part of the message creation elements 500 and 600 in FIGS. 5 and 6, respectively.

In some example embodiments, the transmission module 340 is configured to transmit the message to only the second user, omitting any other users connected to the first user or the second user from being included as recipients of the private message, based on the user input requesting transmission of the message. In some example embodiments, the message comprises the user-entered text.

In some example embodiments, how the first user responds to digital content items 410 in the data feed 405 of the first user is used to determine what digital content items 410 to display in the data feed 405 of the first user in the future, such that the first user selecting the first selectable user interface element 416 and sending a private message to the other user associated with the digital content item 410 is used as an indication of relevance of the digital content item 410 and any similar digital content items to the first user, resulting in an increased likelihood that similar digital content items 410 are displayed in the data feed of the first user. In some example embodiments, the feed system 216 is configured to interpret the event of the first user messaging the second user in association with the display of the digital content item 410A to the first user as a signal that the first user is responsive to the digital content item 410A and other digital content items 410 that are similar to the digital content item 410A (e.g., similar type, similar topic, similar author or creator). The feed system 216 may use this signal to determine that digital content items 410 that are determined to be similar to the digital content item 410A (e.g., similar type, similar topic, similar author or creator) are therefore relevant to the first user. In some example embodiments, the feed system 216 uses these signals to determine which digital content items 410 to display to the first user in the future.

In some example embodiments, the selection module 350 is configured to store a record of the first user messaging the second user in association with the display of the digital content item 410A to the first user. For example, the record may be stored in the database(s) 360. In some example embodiments, the storing of the record is performed in response to, or otherwise based on, the transmission of the message. In some example embodiments, the selection module 350 determines one or more other digital content items 410 to display to the first user based on the stored record of the first user messaging the second user in association with the display of the digital content item 410A to the first user. For example, the selection module 350 may use the stored record as training data in a machine learning algorithm that generates a model for selecting digital content items 410 to display to the first user, and then use the model to select the digital content items 410 to display to the first user. The user interface module 330 may then cause the other digital content item(s) 410 to be displayed on the computing device of the first user. In some example embodiments, the other digital content item(s) are displayed within the data feed 405 of the first user.

In some example embodiments, the digital content item 410 corresponding to the first selectable user interface element 416 that is selected by the first user is associated with a second user that is a company or some other type of organization or entity (e.g., a brand) other than a human. In such embodiments, the user interface module 330 may auto-populate the address field 510 of the message creation element 500 or 600 with an e-mail account of an administrator of the profile or page of the organization or entity. Some profiles or pages of organizations and entities have multiple administrators, and therefore multiple administrator e-mail accounts. In some example embodiments, the user interface module 330 selects a single one of multiple administrator e-mail accounts, and uses that selected single administrator e-mail account in the address field 510, omitting any other administrator e-mail accounts. The selection of the single administrator e-mail account may he based on one or more factors, including, but not limited to, how many messages are in the inboxes of the administrators (e.g., selecting the administrator e-mail account with the fewest number of messages in its inbox), and any history of previous interaction between the first user and a particular administrator (e.g., selecting the administrator e-mail account that the first user has interacted with the most). In some example embodiments, the user interface module 330 auto-populates the address field 510 with all of the available administrator e-mail accounts of the corresponding organization or entity, thereby leaving the decision as to which administrator to direct the message in the hands of the organization or entity, which may funnel the message to one or more of the administrators as it sees fit.

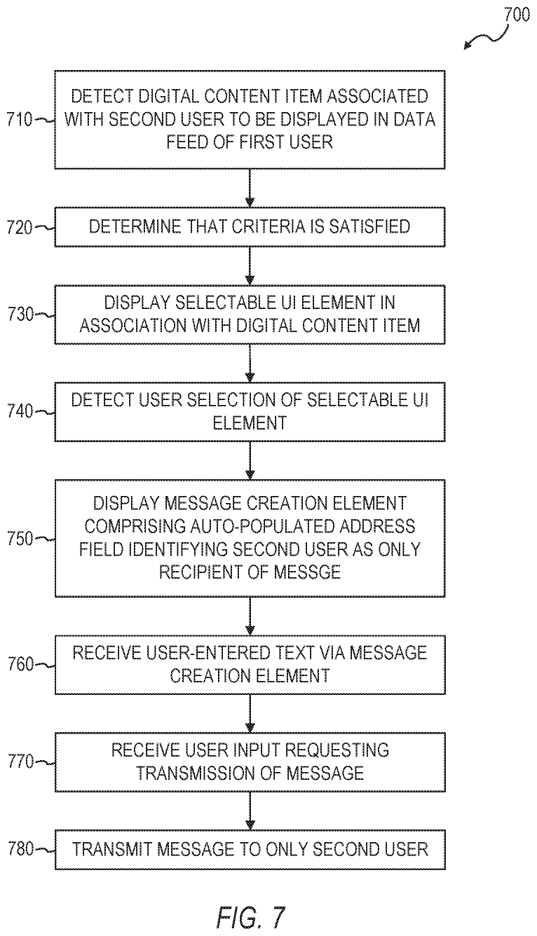

FIG. 7 is a flowchart illustrating a method 700 of providing a user interface configured to enable a user to efficiently and conveniently reply privately to a posting of a digital content item within a data feed of the user, in accordance with an example embodiment. The method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the feed system 216 of FIG. 3, or any combination of one or more of its modules, as described above.

At operation 710, the feed system 216 detects that a digital content item is to be displayed in a data teed of a first user of an online service. In some example embodiments, the digital content item is associated with a second user of the online service. In some example embodiments, the digital content item comprises an online post created by the second user. In some example embodiments, the digital content item comprises an indication of a viral action of the second user directed to an online post. Examples of the viral action include, but are not limited to, liking the online post, commenting on the online post, and sharing the online post.

At operation 720, the feed system 216 determines that a criteria is satisfied. In some example embodiments, the criteria comprises a connection criteria comprising a requirement that the first user and the second user have a connection of at least a predetermined degree. For example, the predetermined degree may be a first degree connection. However, it is contemplated that other connection degrees (e.g., second degree connection, third degree connection, etc., may be used as the predetermined degree, such that the connection between the first user and the second user is at least of the predetermined degree (e.g., a second degree connection would satisfy a connection criteria having a predetermined degree of a third degree connection, since the second degree connection is a higher or stronger degree connection than a third degree connection). In some example embodiments, the criteria comprises a criteria other than the connection criteria, such as criteria based on at least one of the digital content item, profile data of the first user, and profile data of the second user associated with the digital content item. For example, the other criteria may be that the profile data of the first user and the profile data of the second user are determined to be sufficiently similar (e.g., the first user and the second user have similar interests, work for the same company, or work in similar industries), or that the digital content item is of a particular type (e.g., the digital content item comprises an indication of a job opportunity).

At operation 730, the feed system 216 causes a first selectable user interface element to be displayed in association with the digital content item in the data feed of the first user within a user interface of a computing device of the first user based on the determination at operation 720 that the criteria is satisfied. In some example embodiments, the first selectable user interface element comprises a selectable icon. However, other types of selectable user interface elements are also within the scope of the present disclosure.

At operation 740, the feed system 216 detects a user selection of the first selectable user interface element via the user interface of the computing device. Examples of the user selection include, but are not limited to, a clicking or a tapping of the first selectable user interface element by the first user via the computing device.

At operation 750, the feed system 216 causes a message creation element to be displayed within the user interface of the computing device in response to the detection at operation 740 of the user selection of the first selectable user interface element. In some example embodiments, the message creation element is configured to receive user-entered text to include in a message to be transmitted via the message creation element. For example, the message creation element may comprise a text field in which the first user may enter and edit text to be included in the message. In some example embodiments, the message creation element comprises an address field that is auto-populated to identify the second user as the only recipient of the message, thereby automatically configuring the message as a private message between only the first user and the second user, omitting any other users connected to the first user or the second user from being included as recipients of the private message. In some example embodiments, the message creation element is auto-populated with an indication that the message will include a representation of the digital content item. Examples of the representation of the digital content item include, but are not limited to, at least a portion of the digital content item and a link to the digital content item. In some example embodiments, the representation of the digital content item comprises the link to the digital content item, and the message creation element is configured to enable the first user to edit the link to the digital content item.

At operation 760, the feed system 216 receives user-entered text via the message creation element. For example, the first user may enter or edit text within a text field of the message creation element.

At operation 770, the feed system 216 receives a user input requesting transmission of the message. For example, the first user may request transmission of the message by selecting (e.g., clicking, tapping) a selectable user interface element displayed in association with the message creation element, such as a selectable “SEND” button presented as part of the message creation element.

At operation 780, the feed system 216 transmits the message to only the second user, omitting any other users connected to the first user or the second user from being included as recipients of the private message, based on the user input requesting transmission of the message. In some example embodiments, the message comprises the user-entered text.

It is contemplated that any of the other features described within the present disclosure can be incorporated into the method 700.

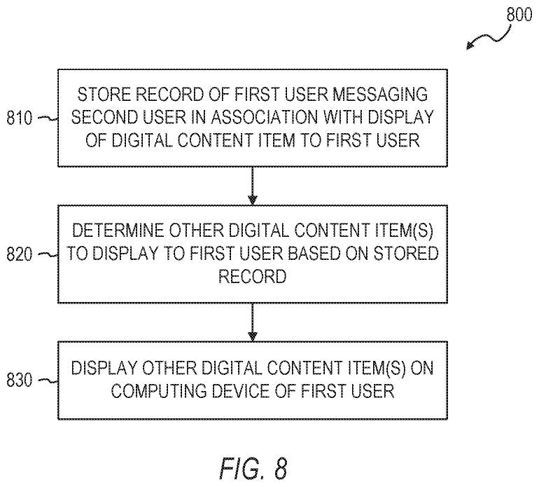

FIG. 8 is a flowchart illustrating a method 800 of using the user's private reply to determine other digital content items to display to the user, in accordance with an example embodiment. The method 800 can be performed by processing logic that can comprise hardware (e.g., circuitry, dedicated logic, programmable logic, microcode, etc.), software (e.g., instructions run on a processing device), or a combination thereof. In one implementation, the method 800 is performed by the feed system 216 of FIG. 3, or any combination of one or more of its modules, as described above. In some example embodiments, the method 800 is performed subsequent to the performance of operation 780 of the method 700 in FIG. 7.

At operation 810, the feed system 216 stores a record of the first user messaging the second user in association with the display of the digital content item to the first user. In some example embodiments, the storing of the record is performed based on the transmission of the message at operation 780 of the method 700 in FIG. 7.

At operation 820, the feed system 216 determines one or more other digital content items to display to the first user based on the stored record of the first user messaging the second user in association with the display of the digital content item to the first user. For example, the feed system 216 may use the stored record as training data in a machine learning algorithm that generates a model for selecting digital content items to display to the first user, and then use the model to select the digital content items to display to the first user.

At operation 830, the feed system 216 causes the other digital content item(s) determined at operation 820 to be displayed on the computing device of the first user. In some example embodiments, the other digital content item(s) are displayed within the data feed of the first user.

It is contemplated that any of the other features described within the present disclosure can be incorporated into the method 800.

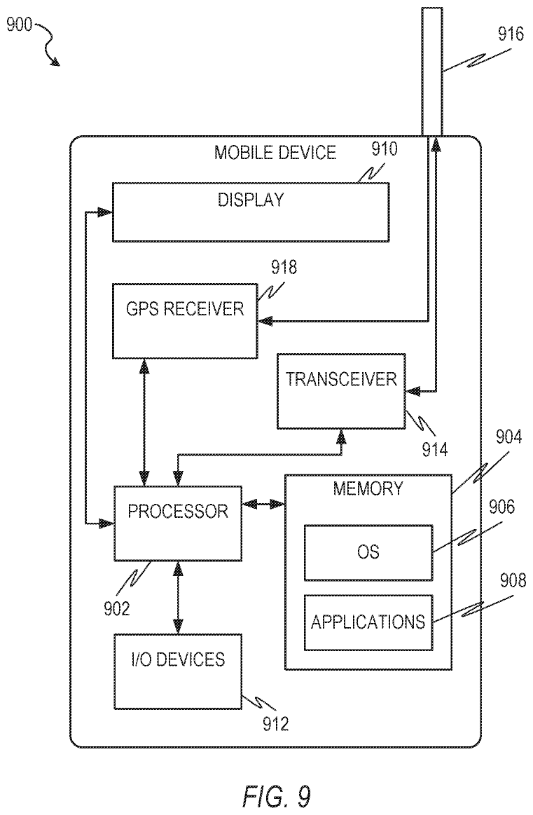

FIG. 9 is a block diagram illustrating a mobile device 900, according to an example embodiment. The mobile device 900 can include a processor 902. The processor 902 can be any of a variety of different types of commercially available processors suitable for mobile devices 900 (for example, an XScale architecture microprocessor, a Microprocessor without Interlocked Pipeline Stages (MIPS) architecture processor, or another type of processor). A memory 904, such as a random access memory (RAM), a Flash memory, or other type of memory, is typically accessible to the processor 902. The memory 904 can be adapted to store an operating system (OS) 906, as well as application programs 908, such as a mobile location-enabled application that can provide location-based services (LBSs) to a user. The processor 902 can be coupled, either directly or via appropriate intermediary hardware, to a display 910 and to one or more input/output (I/O) devices 912, such as a keypad, a touch panel sensor, a microphone, and the like. Similarly, in some embodiments, the processor 902 can be coupled to a transceiver 914 that interfaces with an antenna 916. The transceiver 914 can be configured to both transmit and receive cellular network signals, wireless data signals, or other types of signals via the antenna 916, depending on the nature of the mobile device 900. Further, in some configurations, a GPS receiver 918 can also make use of the antenna 916 to receive GPS signals.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

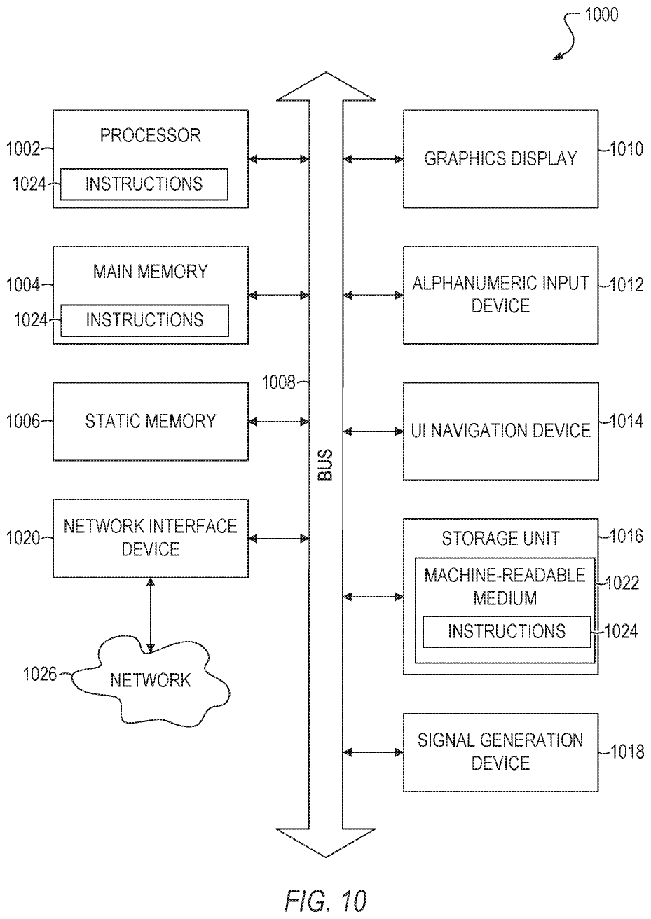

FIG. 10 is a block diagram of an example computer system 1000 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a graphics display unit 1010 (e.g., a liquid crystal display (LCD) or a cathode ray tube (CRT)). The computer system 1000 also includes an alphanumeric input device 1012 (e.g., a keyboard or a touch-sensitive display screen), a user interface (UI) navigation device 1014 (e.g., a mouse), a storage unit 1016, a signal generation device 1018 (e.g., a speaker) and a network interface device 1020.

The storage unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding or carrying instructions (e.g., instructions 1024) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and. DVD-ROM disks.

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

The following numbered examples are embodiments.
1. A computer-implemented method comprising: detecting, by a computer system having a memory and at least one hardware processor, that a digital content item is to be displayed in a data feed of a first user of an online service, the digital content item being associated with a second user of the online service;
   determining, by the computer system, that the first user has a connection with the second user that satisfies a connection criteria, the connection criteria comprising the connection being of at least a predetermined degree;
   causing, by the computer system, a first selectable user interface element to be displayed in association with the digital content item in the data feed of the first user within a user interface of a computing device of the first user based on the determining that the first user has the connection with the second user that satisfies the connection criteria;
   detecting, by the computer system, a user selection of the first selectable user interface element via the user interface of the computing device; and
   causing, by the computer system, a message creation element to be displayed within the user interface of the computing device in response to the detecting of the user selection of the first selectable user interface element, the message creation element being configured to receive user-entered text to include in a message to be transmitted via the message creation element, and the message creation element comprising an address field that is auto-populated to identify the second user as the only recipient of the message.
2. The computer-implemented method of example 1, further comprising:
   receiving, by the computer system, the user-entered text via. the message creation element;
   receiving, by the computer system, a user input requesting transmission of the message; and
   transmitting, by the computer system, the message to only the second user based on the user input requesting transmission of the message, the message comprising the user-entered text.
3. The computer-implemented method of example 2, further comprising:
   storing, by the computer system, a record of the first user messaging the second user in association with the display of the digital content item to the first user;
   determining, by the computer system, one or more other digital content items to display to the first user based on the stored record of the first user messaging the second user in association with the display of the digital content item to the first user; and
   causing, by the computer system, the other digital content items to be displayed on the computing device of the first user.
4. The computer-implemented method of any one of examples 1 to 3, wherein the message creation element is auto-populated with an indication that the message will include a representation of the digital content item, the representation of the digital content item comprising the digital content item or a link to the digital content item.
5. The computer-implemented method of example 4, wherein the representation of the digital content item comprises the link to the digital content item, and the message creation element is configured to enable the first user to edit the link to the digital content item.
6. The computer-implemented method of any one of examples 1 to 5, wherein the predetermined degree is a first degree connection.
7. The computer-implemented method of any one of examples 1 to 6, wherein the digital content item comprises an online post created by the second user.
8. The computer-implemented method of any one of examples 1 to 7, wherein the digital content item comprises an indication of a viral action of the second user directed to an online post.
9. The computer-implemented method of example 8, wherein the viral action comprises liking the online post, commenting on the online post, or sharing the online post.
10. The computer-implemented method of any one of examples 1 to 9, further comprising:
   detecting, by the computer system, that another digital content item is to be displayed in the data feed of the first user, the digital content item being associated with a third user of the online service;
   determining, by the computer system, that another criteria is satisfied based on at least one of the digital content item, profile data of the first user, and profile data of the third user;
   causing, by the computer system, a second selectable user interface element to be displayed in association with the other digital content item in the data feed of the first user within another user interface of the computing device of the first user based on the determining that the other criteria is satisfied;
   detecting, by the computer system, another user selection of the second selectable user interface element via the other user interface of the computing device; and
   causing, by the computer system, another message creation element to be displayed within the other user interface of the computing device in response to the detecting of the other user selection of the second selectable user interface element, the other message creation element being configured to receive other user-entered text to include in another message to be transmitted via the other message creation element, and the other message creation element comprising another address field that is auto-populated to identify the third user as the only recipient of the other message.
11. A system comprising:
   at least one processor; and
   a non-transitory computer-readable medium storing executable instructions that, when executed, cause the at least one processor to perform the method of any one of examples 1 to 10.
12. A non-transitory machine-readable storage medium, tangibly embodying a set of instructions that, when executed by at least one processor, causes the at least one processor to perform the method of any one of examples 1 to 10,
13. A machine-readable medium carrying a set of instructions that, when executed by at least one processor, causes the at least one processor to carry out the method of any one of examples 1 to 10.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
detecting, by a computer system having a memory and at least one hardware processor, that a digital content item is to be displayed in a data feed of a first user of an online service, the digital content item being associated with a second user of the online service;
determining, by the computer system, that the first user has a connection with the second user that satisfies a connection criteria, the connection criteria comprising the connection being of at least a predetermined degree;
causing, by the computer system, a first selectable user interface element to be displayed in association with the digital content item in the data feed of the first user within a user interface of a computing device of the first user based on the determining that the first user has the connection with the second user that satisfies the connection criteria;
detecting, by the computer system, a user selection of the first selectable user interface element via the user interface of the computing device; and
causing, by the computer system, a message creation element to be displayed within the user interface of the computing device in response to the detecting of the user selection of the first selectable user interface element, the message creation element being configured to receive user-entered text to include in a message to be transmitted via the message creation element, and the message creation element comprising an address field that is auto-populated to identify the second user as the only recipient of the message.

2. The computer-implemented method of claim 1, further comprising:
receiving, by the computer system, the user-entered text via the message creation element;
receiving, by the computer system, a user input requesting transmission of the message; and
transmitting, by the computer system, the message to only the second user based on the user input requesting transmission of the message, the message comprising the user-entered text.

3. The computer-implemented method of claim 2, further comprising:
storing, by the computer system, a record of the first user messaging the second user in association with the display of the digital content item to the first user;
determining, by the computer system, one or more other digital content items to display to the first user based on the stored record of the first user messaging the second user in association with the display of the digital content item to the first user; and
causing, by the computer system, the other digital content items to be displayed on the computing device of the first user.

4. The computer-implemented method of claim 1, wherein the message creation element is auto-populated with an indication that the message will include a representation of the digital content item, the representation of the digital content item comprising the digital content item or a link to the digital content item.

5. The computer-implemented method of claim 4, wherein the representation of the digital content item comprises the link to the digital content item, and the message creation element is configured to enable the first user to edit the link to the digital content item.

6. The computer-implemented method of claim 1, wherein the predetermined degree is a first degree connection.

7. The computer-implemented method of claim 1, wherein the digital content item comprises an online post created by the second user.

8. The computer-implemented method of claim 1, wherein the digital content item comprises an indication of a viral action of the second user directed to an online post.

9. The computer-implemented method of claim 8, wherein the viral action comprises liking the online post, commenting on the online post, or sharing the online post.

10. The computer-implemented method of claim 1, further comprising:
detecting, by the computer system, that another digital content item is to be displayed in the data feed of the first user, the digital content item being associated with a third user of the online service;
determining, by the computer system, that another criteria is satisfied based on at least one of the digital content item, profile data of the first user, and profile data of the third user;
causing, by the computer system, a second selectable user interface element to be displayed in association with the other digital content item in the data feed of the first user within another user interface of the computing device of the first user based on the determining that the other criteria is satisfied;
detecting, by the computer system, another user selection of the second selectable user interface element via the other user interface of the computing device; and
causing, by the computer system, another message creation element to be displayed within the other user interface of the computing device in response to the detecting of the other user selection of the second selectable user interface element, the other message creation element being configured to receive other user-entered text to include in another message to be transmitted via the other message creation element, and the other message creation element comprising another address field that is auto-populated to identify the third user as the only recipient of the other message.

11. A system comprising:
at least one hardware processor; and
a non-transitory machine-readable medium embodying a set of instructions that, when executed by the at least one hardware processor, cause the at least one hardware processor to perform operations, the operations comprising:
detecting that a digital content item is to be displayed in a data feed of a first user of an online service, the digital content item being associated with a second user of the online service;
determining that the first user has a connection with the second user that satisfies a connection criteria, the connection criteria comprising the connection being of at least a predetermined degree;
causing a first selectable user interface element to be displayed in association with the digital content item in the data feed of the first user within a user interface of a computing device of the first user based on the determining that the first user has the connection with the second user that satisfies the connection criteria;
detecting a user selection of the first selectable user interface element via the user interface of the computing device; and
causing a message creation element to be displayed within the user interface of the computing device in response to the detecting of the user selection of the first selectable user interface element, the message creation element being configured to receive user-entered text to include in a message to be transmitted via the message creation element, and the message creation element comprising an address field that is auto-populated to identify the second user as the only recipient of the message.

12. The system of claim 11, wherein the operations further comprise:
receiving the user-entered text via the message creation element;
receiving a user input requesting transmission of the message; and
transmitting the message to only the second user based on the user input requesting transmission of the message, the message comprising the user-entered text.

13. The system of claim 12, wherein the operations further comprise:
storing a record of the first user messaging the second user in association with the display of the digital content item to the first user;
determining one or more other digital content items to display to the first user based on the stored record of the first user messaging the second user in association with the display of the digital content item to the first user; and
causing the other digital content items to be displayed on the computing device of the first user.

14. The system of claim 11, wherein the message creation element is auto-populated with an indication that the message will include a representation of the digital content item, the representation of the digital content item comprising the digital content item or a link to the digital content item.

15. The system of claim 14, wherein the representation of the digital content item comprises the link to the digital content item, and the message creation element is configured to enable the first user to edit the link to the digital content item.

16. The system of claim 11, wherein the predetermined degree is a first degree connection.

17. The system of claim 11, wherein the digital content item comprises an online post created by the second user.

18. The system of claim 11, wherein the digital content item comprises an indication of a viral action of the second user directed to an online post.

19. The system of claim 18, wherein the viral action comprises liking the online post, commenting on the online post, or sharing the online post.

20. A non-transitory machine-readable medium embodying a set of instructions that, when executed by at least one hardware processor, cause the at least one hardware processor to perform operations, the operations comprising:
detecting that a digital content item is to be displayed in a data feed of a first user of an online service, the digital content item being associated with a second user of the online service;
determining that the first user has a connection with the second user that satisfies a connection criteria, the connection criteria comprising the connection being of at least a predetermined degree;
causing a first selectable user interface element to be displayed in association with the digital content item in the data feed of the first user within a user interface of a computing device of the first user based on the determining that the first user has the connection with the second user that satisfies the connection criteria;
detecting a user selection of the first selectable user interface element via the user interface of the computing device; and
causing a message creation element to be displayed within the user interface of the computing device in response to the detecting of the user selection of the first selectable user interface element, the message creation element being configured to receive user-entered text to include in a message to be transmitted via the message creation element, and the message creation element comprising an address field that is auto-populated to identify the second user as the only recipient of the message.
